(19) United States
(12) Patent Application Publication
(10) Pub. No.: US 2026/0175496 A1
(43) Pub. Date: Jun. 25, 2026

(54) Production process determination device and method

(71) Applicant: NETSTAL Maschinen AG, Naefels (CH)

(72) Inventor: Björn DENZLER, Rapperswil-Jona (CH)

(21) Appl. No.: 19/418,247

(22) Filed: Dec. 12, 2025

(30) Foreign Application Priority Data
Dec. 23, 2024 (DE) 102024139624.5
Mar. 14, 2025 (DE) 102025109892.1

(51) Int. Cl. B29C 45/76; B29L 31/00

(52) U.S. Cl. CPC B29C 45/76; B29C 2945/76949; B29L 2031/753

(57) ABSTRACT

A method for at least partially automatic determination of at least one production process variable for manufacturing a predetermined target plastic molded part by an injection molding machine. The apparatus includes production devices having a plastic supply device for supplying the plastic to be processed as raw material, a plasticizing device for plasticizing and/or homogenizing the plastic to be processed, an injection device for injecting the plasticized and/or homogenized plastic into at least one molding device, and/or the at least one molding device for molding the injected plastic into a plastic molded part, wherein the apparatus and/or the production devices can be adjusted according to predetermined and/or predeterminable production process variables which are characteristic of the production process of the plastic products to be manufactured.

### CROSS REFERENCE TO RELATED APPLICATION

This application claims benefit to German Patent Application Serial No. 102024139624.5, filed Dec. 23, 2024 and German Patent Application Serial no. 102025109892.1, filed Mar. 14, 2025, the contents of which are disclosed herein by reference.

### BACKGROUND OF THE INVENTION

The present invention relates to a production process determination device and a method for at least partially automatically determining at least one production process variable for manufacturing a predetermined target plastic molded part using an apparatus for, in particular, molded production of plastic molded parts. Furthermore, the present invention relates to an apparatus for the molded production of plastic molded parts and a method for operating the apparatus.

In the prior art, injection molding machines are known in which the production process is created in individual steps by manual input at the operating unit. For this purpose, suitable components and commands that execute the movements of the machine axes must be interconnected.

Some of the existing components often have to be created and/or configured in advance in the form of auxiliary controls. Not all components require an auxiliary control, but the basic components of an injection molding machine, such as the clamping unit, injection unit, and the like, are always present and must be configured. All components must also be parameterized manually in order to obtain a functioning production process.

Detailed knowledge of the operation and the injection molding process is necessary to create a production process. As a rule, only specially trained personnel can perform this task.

From EP 2618981 A1 a universal auxiliary control system for an injection molding machine is known, which comprises an operating unit and a machine control coupled to it. Furthermore, the auxiliary control comprises a converter supplied by the machine control and a controllable electric motor supplied by the converter. The controllable electric motor is connected to a standardized interface which can be connected either to a complementary standardized shaft interface of a mechanical or a hydraulic operating element.

From EP 2 564 278 B1 a method for displaying a programmable sequence for one or more machines with a cyclically recurring machine operating sequence is known. A sequence of individual process steps and their dependencies, programmed or modified using command functions, is displayed on a screen.

The present invention is based on the object of overcoming the disadvantages known from the prior art and providing a user-friendly setting of a production sequence in an injection molding process.

### SUMMARY OF THE INVENTION

In a method according to the invention for the at least partially automatic, preferably fully automatic, determination of at least one production process variable for the manufacture of a predetermined target plastic molded part by an apparatus for the molded production of plastic molded parts, the apparatus (for the manufacture of the plastic products and/or plastic molded parts to be produced) has a plurality of production devices.

The predetermined target plastic molded part is preferably a predetermined plastic product that is intended to be manufactured (in particular in large quantities and/or as a mass-produced item).

The apparatus is preferably an injection molding machine. The plastic molded parts are preferably injection molded parts (also known as injections). Consequently, the target plastic molded part is (also) preferably a target injection molded part.

Preferably, the apparatus is an apparatus for primary forming of plastic molded parts from plastic (as raw material).

The production devices of the plurality of production devices are preferably at least partially different from one another.

The plurality of production devices of the apparatus preferably comprises a plastic supply device for supplying the plastic to be processed (as raw material or preferably available as raw material), a plasticizing device for plasticizing and/or homogenizing the plastic to be processed, preferably an injection device for injecting the plasticized and/or homogenized plastic into at least one molding device, and/or the at least one molding device for molding the injected plastic into a plastic molded part. The injection device (injection unit) may be separate or integrated into the plasticizing device.

Preferably, the molding device is an injection molding tool or comprises an injection molding tool. The injection molding tool is preferably multi-part (particularly preferably two-part or, for example in the case of stack tools—for example for thin-walled packaging—three-part). Preferably, the molded production is an injection molding process.

In addition, the apparatus may comprise further conveyor devices (as production devices of the plurality of production devices) for introducing raw materials into the manufacturing process and/or (at least) one processing device for processing raw materials (such as the plastic to be processed).

In addition or alternatively, the apparatus may have an ejector device (as one production device of the plurality of production devices) which detaches or removes the plastic molded part(s) formed in the molding device (after the molding process) from the molding device. Thus, after the molding device has been opened, the ejector device (designed, for example, as an ejector plate) can eject all plastic molded parts formed in the molding device (preferably simultaneously) from the molding device (in which, for example, mechanically pressure is applied to the individual plastic molded parts).

In addition or alternatively, the apparatus may comprise a removal device for removing (finished) plastic molded parts from the molding device and/or from a collection container in which the plastic molded parts are collected after their manufacture (as a production device of the plurality of production devices).

In addition or alternatively, the apparatus may comprise an inspection device (as a production device of the plurality of production devices) which inspects the (finished) plastic molded parts for defects.

The plurality of production devices preferably comprises at least two, preferably at least three, preferably at least four production devices, each of which is selected from a group of production devices comprising a plastic supply device for supplying the plastic to be processed (as raw material or preferably available as raw material), a plasticizing device for plasticizing and/or homogenizing the plastic to be processed, preferably an injection device for injecting the plasticized and/or homogenized plastic into at least one molding device and/or the at least one molding device for molding the injected plastic into a plastic molded part, a conveyor device for introducing raw materials into the manufacturing process, a processing device for processing raw materials (such as the plastic to be processed), an ejector device, a removal device (comprising a tool, automation and/or robotics) for removing (finished) plastic molded parts from the molding device and/or from a collection container, an inspection device for inspecting the (finished) plastic molded parts for defects and the like, and combinations thereof. The injection device (injection unit) may be separate or integrated into the plasticizing device.

Preferably, the apparatus is suitable and intended to produce (one after the other) a plurality of (essentially) identical plastic products (to be produced) and/or plastic molded parts. Preferably, the plastic molded parts are manufactured (fully) automatically, i.e., preferably without manual production steps and/or without manual intervention, and particularly preferably fully automatically, while at most one operator monitors the production.

It is conceivable that, for example, within one hour, at least 1,000, preferably at least 10,000, preferably at least 11,000 (for example, in the case of thin-walled packaging as plastic molded parts to be manufactured), preferably at least 50,000, preferably at least 65,000 (e.g., PET plastic molded parts to be manufactured), preferably at least 100,000, and particularly preferably at least 300,000 (identical) plastic molded parts can be manufactured within one hour using an apparatus and/or exactly one molding device (which may have several cavities, for example).

Preferably, the apparatus in a production operation has a fixed and/or predetermined cycle time. The cycle time is the time required by the apparatus, e.g., an injection molding machine, to produce or manufacture a plastic molded part, e.g., an injection molded part (wherein during a production cycle, several plastic molded parts are often manufactured simultaneously in parallel by a plurality of cavities in the molding device or in the injection mold). The cycle time is preferably in the range between 0.5 seconds and 1 minute, preferably between 0.5 seconds and 5 seconds, preferably between 1 second and 3 seconds, preferably between 1.5 seconds and 3 seconds, preferably between 1.5 seconds and 2.5 seconds, and particularly preferably between 1.5 seconds and 2 seconds. For example, the cycle time for manufacturing closures for water beverage bottles may be 1.9 seconds.

Preferably, the molding device has more than one cavity so that more than one plastic molded part is produced in a production cycle. Preferably, the molding device (preferably each molding device of the apparatus) has at least two, preferably at least 32, preferably at least 64, and particularly preferably at least 128 (in particular identical) cavities. Preferably, at least two, preferably at least 32, preferably at least 64, and particularly preferably at least 128 (identical) plastic molded parts are produced simultaneously or in parallel in each individual production cycle (using the one molding device or the one injection mold). Preferably, the molding device (preferably each molding device of the apparatus) has no more than 512, preferably no more than 256, and particularly preferably no more than 128 (identical) cavities (for the simultaneous and/or parallel production of plastic molded parts during a production cycle).

The apparatus, and preferably the plurality of production devices, can be adjusted according to a predetermined and/or predeterminable plurality of production process variables, which are characteristic of the production process of the plastic products to be manufactured.

The predetermined plurality of production process variables can preferably be stored on a (non-temporary) storage device of the apparatus. Preferably, the storage device is a (fixed) component of the apparatus or an internal storage device of the apparatus. However, it would also be conceivable for the storage device to be an external storage device (in relation to the apparatus), such as a cloud-based storage device.

Preferably, the plurality of production process variables depends on the plastic product and/or plastic molded part that can be or is to be produced in the apparatus. For example, the injection quantity and/or injection speed of plastic into the molding device may depend on the size and/or shape of the plastic molded part to be produced.

Preferably, the apparatus has (at least) one control device which controls the apparatus and, in particular, the plurality of production devices as a function of the production process variables. The production process variables can refer to a relative temporal control of the components and/or machine parts of the apparatus to be controlled within a production cycle.

Preferably, the plurality of production process variables specifies a cyclic sequence of the (plurality of) production devices and/or the components and/or machine parts of the apparatus to be controlled. In this case, the sequence of individual process steps is preferably specified as a function of production process variables. Preferably, the plurality of production process variables also specifies a sequence rule and/or temporal correlation for individual process steps of the apparatus (preferably during a production cycle) (to be performed by at least one production device and/or component and/or by several production devices and/or components).

The (machine) components of the apparatus may be, for example, the components “dosing unit” (e.g., for dosing a plastic melt or the plastic to be processed), “closing unit (e.g., closing the molding device),” “injection axis,” “plasticizing device (e.g., injection nozzle),” “ejection device,” “injection pressure (e.g., nozzle pressure),” and/or core pull. Production process variables of the plurality of production process variables can, for example, each specify a temporal progression of the (respective) axis positions.

In addition, production process variables can also specify production parameters, in particular production parameters that have a temporal influence on a production operation of the apparatus. For example, a production process variable can specify a temperature that is characteristic of the temperature at which a process step is carried out. Depending on the temperature, there may be a difference in time, if an axis (such as an injection axis (injection device)) must be moved at a lower speed (e.g., 50 mm/s) or at a higher speed (e.g., 450 mm/s). A dosing process for the plastic to be processed and/or an injection process (using the injection device) can also be carried out in a shorter or longer time interval, which may depend, for example, on a rotational speed (predetermined and/or predeterminable as a production process variable) of the plasticizing device (e.g., melting screw) and/or the material of the plastic to be processed.

Preferably, at least one and particularly preferably several production process variables (of the plurality of production process variables) are characteristic of at least one production process step, which can be selected from a group of production process steps comprising a closing operation of the molding device (e.g., injection mold), approaching or moving the plasticizing device, approaching or moving the injection device, an injection process of the injection device, a holding pressure process of the injection and/or plasticizing device, a cooling process (for cooling the molding device), an opening process of the molding device, an ejection process of the plastic molded parts formed in the molding device (by the ejection device), a return movement or movement of the plasticizing device (screw retraction) and/or the injection device, a metering of a plastic melt or the plastic to be processed, a lifting of the plasticizing and/or injection device from the molding device (tool) and the like, as well as combinations thereof.

In each (subsequent) production cycle, the operation of the apparatus or the production devices is controlled according to this plurality of production process variables.

The plurality of production process variables can preferably be specified and/or changed (by an operator) by an operator input (for which an operating device or a human-machine interface may be provided on the apparatus).

At least one production process variable and preferably several production process variables (of the plurality of production process variables) can specify at least one movement variable of movable parts of the apparatus, for example the ejector device.

At least one production process variable, and preferably several production process variables (of the plurality of production process variables), can specify a buffer time, which is not directly included in the cycle time (and is therefore not relevant to the cycle time), of a component of the apparatus.

At least one production process variable, and preferably several production process variables (of the plurality of production process variables), may specify an end time of a production process step at which the production process step must be completed (so that, for example, a subsequent or next production process step can be initiated).

According to the invention, a plurality of production process data sets are provided for production processes that have been realized and/or already completed for the manufacture of previous and/or past target plastic molded parts. This plurality of production process data sets can, for example, be retrieved from the (internal or external) storage device of the apparatus.

Based on the plurality of production process data sets and depending on at least one target plastic molded part variable characteristic of the predetermined target plastic molded part, at least one production process variable and, preferably, several production process variables from the plurality of production process variables are determined.

In other words, production process data sets for plastic molded parts that have already been produced are used to determine an automatically generated production process for a predetermined target plastic molded part that has not yet been manufactured.

The applicant has found that the target plastic part already provides a strong indication of the plastic used and the tool design. For some parts, however, this is more variable, in which case it would be preferable to consult the machine operator.

The production process data sets preferably refer to different (but already manufactured) plastic products. Each production process data set refers to exactly one (already manufactured) plastic product or plastic molded part. The respective production process data set is preferably characteristic of one production process (existing and/or predetermined during manufacture) for the manufacture of the respective plastic product or plastic molded part. The production process data set may relate to data measured during a production cycle and/or predetermined control variables. It is also conceivable that the production process data set contains data averaged over several production cycles.

In other words, it is proposed to use production processes that have already been implemented to automatically create a production process for a predetermined target plastic molded part that has not yet been produced.

In a preferred method, the target plastic molded part is a plastic molded part selected from a group comprising medical technology products and/or products for the pharmaceutical sector and/or the healthcare sector and/or the medical sector, in particular syringes and/or pipette tips and/or pipettes, medical devices from the diagnostics sector, closures, in particular for (beverage) containers (e.g., tethered caps), caps, lids for (beverage) cups or drinking cups, containers, in particular Petri dishes and/or containers for analysis liquids, containers for dairy products (such as yogurt), thin-walled containers, and/or (beverage) cups, and/or packaging, in particular thin-walled packaging, and/or in-mold labeling products and the like, as well as combinations thereof.

Preferably, the target plastic molded part is a mass-produced item that is manufactured in large quantities by the apparatus.

So-called “in-mold labeling” (abbreviated as IML process) is a labeling process for plastic packaging in which pre-printed labels are inserted into the injection mold.

Preferably, the preceding and/or past target plastic molded parts (particularly preferably all of them) for which the production process data sets are provided are of the same type of plastic molded part (as selected from the above group).

The at least one target plastic molded part variable may be at least one plastic molded part parameter (such as an injection molded part parameter) and preferably the plurality of plastic molded part parameters (such as injection molded part parameters), which are preferably selected from a group of plastic molded part parameters (such as injection molded part parameters), which comprise a mass and/or weight of the plastic molded part (such as an injection molded part) to be produced or a characteristic size thereof, a crystallinity around the sprue of the plastic molded part (such as an injection molded part) to be produced or a characteristic size thereof, a presence of black specks, a molding of threaded parts or a characteristic size, shape and/or position tolerances, damage (such as dents) thereof, characteristic mechanical and/or physical variables such as puncture resistance, impact strength, tensile strength of the plastic molded part (e.g., injection molded part) to be produced or characteristic value(s) for this, an effective area of the plastic molded part (e.g., injection molded part) to be produced and/or an effective area of the cavity suitable for producing the plastic molded part (e.g., injection molded part) or a characteristic value for this, a value characteristic of a geometry of the plastic molded part (e.g., injection molded part) to be produced, a value characteristic of a weight and/or a geometric extension of the plastic molded part (e.g., injection molded part) to be produced, and the like, as well as combinations thereof.

In this case, data, preferably 3D data, is or will be predetermined for the predetermined target plastic molded part. Preferably, the at least one target plastic molded part variable is 3D data of the predetermined target plastic molded part. However, it is also conceivable that the target plastic molded part variable is derived from the 3D data of the predetermined target plastic molded part (automatically, for example, by the apparatus and, particularly preferably, by a production process determination device of the apparatus described below, in particular a processor-based device).

Preferably, the at least one target plastic molded part variable is predetermined by an operator or via an operator input.

The at least one target plastic molded part variable can be entered in writing or verbally (by the operator).

However, it is also conceivable that the at least one target plastic molded part variable is determined by a sensor detection device (such as a camera and/or 3D scanning device), for example of the apparatus, by evaluating the sensor data recorded by the sensor detection device from the predetermined target plastic molded part and/or a prototype for the predetermined target plastic molded part (such as a 3D-printed part).

In a further preferred method, the plurality of production process data sets provided relates to the manufacture of previous and/or past (already manufactured) target plastic molded parts, which originate from the same product category as the predetermined target plastic molded part. This offers the advantage that data on production processes is/are already provided which relate to target plastic molded parts to be manufactured in a similar manner and which have similar properties. As a result, the production processes are often already similar to the production process to be created, so that faster or less computationally intensive creation can be achieved.

In a further preferred method, the provided and/or to be provided plurality of production process data sets is/will be selected and/or provided depending on at least one target plastic molded part variable, which is selected from a group comprising a cross-sectional shape, cross-sectional areas, dimensions, weight, geometric sizes, material, intended use, reusability, an (approximately external) design shape (of the target plastic molded part), such as 3D data of the target plastic molded part, volume, wall thickness, external and/or internal surface size, and the like, as well as combinations thereof. Alternatively or additionally, the plurality of production process data sets provided and/or to be provided may be and/or become selected and/or provided depending on at least one target plastic molded part variable specified above.

For example, a distinction can be made between round and/or rectangular packaging (as target plastic molded parts) to be manufactured and/or manufactured (in cross-section). The plurality of production process data sets provided preferably also refers only to round or rectangular manufactured packaging.

Preferably, when determining the at least one production process variable based on the plurality of production process data sets depending on the target plastic molded part variable, preference is given to plastic molded part variables that are characteristic of the respective preceding target plastic molded parts to whose production process the respective production process data set refers. For example, this plastic molded part variable(s) may also be (a) target plastic molded part variable(s) (as described above) which specifies at least one property and/or size characteristic of the preceding target plastic molded part (such as the 3D data of the tool or the plastic part). Since the production process of the preceding target plastic molded part has already been implemented, the plastic molded part variable(s) obtained during the production of the target plastic molded part or its measured variables and/or properties can be used as plastic molded par variables additional or alternative to the target plastic molded part variables (the 3D shape of the produced target plastic molded part could also be measured and 3D data determined for this).

At least one (such) plastic molded part variable (preferably several) can be assigned to each of the production process data sets of the plurality of production process data sets. In addition or alternatively, the production process data sets of the plurality of production process data sets may (each) comprise at least one (such) plastic molded part variable (preferably several). Such an assignment or such an included specification of the plastic molded part variable preferably assigns/includes information about which target plastic molded part should be manufactured by the provided production process data set (characteristic of a realized production process) and/or which was manufactured.

This information or the plastic molded part variables can preferably be used for the selection and/or provision and/or use of the plurality of production process data sets, which are taken into account in the determination of at least one production process variable and preferably in the determination of several production process variables. This means that only production process data sets are used/taken into account with the help of which sufficiently similar previous target plastic molded parts have been produced for the predetermined target plastic molded part to be produced.

In addition or alternatively, the at least one production process variable and, preferably, the several production process variables are determined as a function of these plastic molded part variables (in particular, by only taking into account production process data sets for selected plastic molded part variables when determining them).

In a further preferred method, the plurality of production process data sets provided and/or to be provided is/are selected and/or provided as a function of at least one target plastic molded part variable, which specifies an application (or use) of the predetermined target plastic molded part. This may include, for example, a specific application such as PET preforms and/or closures for beverage containers (for still water and/or carbonated beverages), medical articles (disposables or reusable articles), and/or thin-walled articles and/or packaging, or manufacture according to a special process (foaming, injection molding, or the like).

Preferably, the plurality of production process data sets provided and/or to be provided also includes data characteristic of the respective application, so that the respective data set can be assigned to this application or selected according to a predetermined application (for provision within a plurality of production process data records).

In a preferred method, the provided plurality of production process data sets comprises data collected by the apparatus (by which the predetermined target plastic molded part is to be produced) and/or consists of this (own) collected data. It is also conceivable that production process data sets are used which were/are generated on the basis of data collected in at least one and preferably several different (preferably identical) apparatuses.

This could, for example, be a different apparatus belonging to the same operator of the apparatus. For example, production process data sets could be used which were generated on the basis of apparatuses belonging to the same operator that were used in previous years. This offers the advantage that a large number of production process data sets are available within a short period of time and the production process or production flow can be adapted to the respective operator-specific production operation or its components right from the start. This means that experience and knowledge gained in previous apparatuses can be used immediately after the start of production operation of a new apparatus.

However, it is also conceivable that production process data sets (in particular exclusively and/or as part of the plurality of production process data sets provided) can be used which are/were generated on the basis of data which was/were collected by at least one apparatus and preferably a plurality of (preferably identical) apparatuses from the operator(s) other than the operator of the (relevant) apparatus. This offers the advantage that, for example, several different advantageous possibilities for a production process can be mapped and operator-independent production processes can be determined.

The production process data sets and/or the data used to generate the production process data sets are preferably available in anonymized and/or pseudonymized form, so that the data used cannot be traced back to a specific operator and/or a specific apparatus.

In a further preferred method, the at least one production process variable and, preferably, the plurality of production process variables are determined by a machine learning production process model, which comprises a set of parameters that are set to values that were learned as a result of a training process in which the (provided) plurality of production process data sets relating to production processes that have already taken place for previous/past, preferably different, (already manufactured) target plastic molded parts. Preferably, therefore, embodiments of the production process data sets described above and/or described in more detail below are used as training data or as training data sets.

Preferably, the production process data sets for the (associated) plastic product or plastic molded part comprise characteristic data, such as 3 D data of the tool and/or the plastic molded part. In addition, the production process data sets (used as training data) may comprise values for one or several of the above-mentioned plastic molded part sizes that are characteristic of the plastic product or plastic molded part to be manufactured/manufactured.

Preferably, the machine learning production process model is based on an (artificial) neural network. Preferably, the neural network is a deep neural network (DNN), in which the parameterizable processing chain has a plurality of processing layers, and/or a so-called convolutional neural network (CNN) and/or a recurrent neural network (RNN) and/or a feedforward neural network and/or a GAN (abbreviation for “Generative Adversarial Network”).

Preferably, a production process (for the predetermined target plastic molded part) can be created automatically, for example, by entering the requirements for the production process (of the predetermined target plastic molded part) in writing or verbally, in other words, by a trained neural network. The network was initially trained with production processes that had already been implemented. The created (production) process preferably includes all necessary components, commands, auxiliary controls, and their parameterization.

Preferably, the plurality of production process data sets or variables derived from them are supplied for training into the production process model or the (artificial) neural network to be trained. As described above, these production process data sets may, for example, comprise 3D data of the (then) previously manufactured plastic molded parts or be assigned to them (in the course of whose manufacture the respective production process data sets were generated or determined).

In a preferred embodiment, at least one target plastic molded part variable serves as at least one input variable of the production process model, in particular the (fully) trained production process model, wherein 3D data of the tool and/or the predetermined target plastic part to be manufactured is preferably used as the target plastic molded part variable. Preferably, the machine learning production process model maps the at least one input variable to the at least one production process variable (to be determined), in particular to be used for manufacturing the predetermined target plastic molded part, or a variable characteristic thereof, and/or the machine learning production process model outputs as output variable(s) the at least one production process variable (to be determined), in particular the one to be used for manufacturing the predetermined target plastic molded part, or a variable or variables characteristic thereof (preferably to an operator).

Preferably, (in other words) the input variable of the production process model, in particular the (fully) trained production process model, or in particular the (fully) trained neural network, serves as at least one target plastic molded part variable (which is characteristic of the predetermined target plastic molded part to be produced). As explained above, this target plastic molded part variable can be, for example, 3D data of a tool to be used for manufacturing the predetermined target plastic molded part and/or 3D data of the predetermined target plastic molded part to be manufactured.

Preferably, the production process model or the artificial neural network maps the at least one input variable and preferably maps the input variables to (at least one) output variable(s) depending on a parameterizable processing chain.

Preferably, at least one production process variable (described in more detail above or below) or one or more variables characteristic thereof is/are selected as output variable(s). Preferably, a plurality of production process variables (described in more detail above or below) are selected as output variables, and particularly preferably all production process variables of a production process or for operating the apparatus for manufacturing the target plastic molded part.

For example, the output variable(s) may be selected for an injection speed and/or for a process time of a production process step or for several process times of at least one production process step and/or for a pressure or characteristic variable(s) thereof.

In a further preferred method, the training process is supervised learning.

The production process model is preferably suitable and intended to output continuous variables as output variables (such as values for process times, pressures, speeds, axis positions, and the like).

The production process model may preferably be a deep learning model, a support vector machine (SVM), a k-nearest neighbors model (KNN), and/or a Bayesian model.

The production process model is preferably trained using reinforcement learning. In other words, a so-called reinforcement learning agent can be used here to train the underlying production process model, in particular on an ongoing basis. The training data sets predetermined as training data can, for example, be the training data sets mentioned above or comprise such data sets.

For reinforcement learning, a reward function is predetermined in particular, which rewards, for example, maximization of the performance of the production process model.

The production process model preferably uses a reinforcement learning agent to determine a control variable for a control method and/or regulation method of a production process step (such as those mentioned above), wherein the agent is suitable and intended to explore an environment of the agent i.e., to explore the environment through actions that deviate from the best actions known to the agent, wherein the agent determines an exploration rate and/or decides whether further exploration is to be carried out.

Preferably, the agent generally explores its environment in order to be able to better evaluate the state space. An exploration and/or an exploration amount or reward can be carried out depending on (further) user input, for example verbal and/or written, with which an operator as a user wishes to override and/or change the proposed control and/or regulation.

In a further preferred method, the at least one production process variable and, preferably, the plurality of production process variables are selected from a group of production process variables, which variables comprise those that are characteristic of at least one component of the apparatus, commands or command function(s), control devices and/or parameters of the apparatus and the like, as well as combinations thereof. This offers the advantage that the (entire) (control and/or adjustment) data required to operate the apparatus, which previously had to be created/generated by the operator and predetermined to the apparatus, can be generated automatically.

A command or command function is at least one control command and/or a sequence of control commands by means of which a component and/or at least one production device, preferably for carrying out at least one production process step, in particular the timing of the production process step, is controlled. The command or command function can be pseudocode or code that must first be compiled into machine language before it can be executed by a machine part, or it can be (already) machine-readable code (machine language). These commands or command functions preferably already take into account control variables such as temporal sequences of axis positions, speeds, pressure, temperature, process times, and the like.

In a further preferred method, the determined plurality of production process variables is characteristic of the entire production process.

In a further preferred method, the at least one determined production process variable or the determined plurality of production process variables can be changed by operator input.

In a further preferred method, the at least one determined production process variable or the determined plurality of production process variables can be changed and/or expanded and/or refined by a chat interaction (such as generative AI) with an operator, preferably by means of voice input and/or text input by the operator. This preferably enables a very user-friendly modification option or refinement or adaptation. In other words, the created draft can preferably be expanded and/or refined through chat interaction (generative AI).

In a further preferred method, at least one production process variable to be optimized by an operator is determined for output to the operator. For example, the production process model can determine and/or output a variance for an output variable and/or a prediction probability or a variable characteristic thereof. These variables can be used to determine whether an output variable has a comparatively high probability of being optimizable.

In a further preferred method, the at least one production process variable to be optimized by the operator is output to the operator together with at least one limit value, by which (the operator) is given an optimization range for the production process variable to be optimized. In other words, the system is also preferably able to provide assistance and/or submit optimization suggestions (and output them to the operator by an output device of the apparatus).

In a further preferred method, the sequence of production steps to be performed by the apparatus can be determined and/or is determined by the determined plurality of production process variables.

In a further preferred method, at least one test function and/or several test functions are predetermined and/or can be predetermined, by which the feasibility of a production process determined and/or to be determined on the basis of the determined plurality of production process variables can be automatically checked and/or is checked.

For example, a mandatory temporal sequence or order of predetermined production process steps can be checked. Such a mandatory temporal sequence or order and/or at least one test function can be fixed in advance. However, it is also conceivable that an operator predetermines such a mandatory temporal sequence or order and/or at least one test function.

A test function can also check whether process parameters and/or production process variables comply with a mandatory and/or predetermined value range.

Preferably, an operator must release a setting of the production process variables based on the determined production process variables before operating the apparatus.

Preferably, at least one production process variable and preferably several production process variables (the plurality of production process variables) are each a production parameter which is characteristic of at least one production process step of the apparatus.

A production parameter is preferably a variable that can be predetermined by an operator (in particular at the operating device) of the apparatus, depending on which the at least one production process step can be controlled and/or regulated.

The at least one production parameter and preferably the plurality of production parameters can be selected from a group of production parameters, which include a clamping force of a tool of an injection molding machine, a target breathing of a tool of the injection molding machine, a column elongation, a heating temperature or heating power at the plasticizing of the injection molding machine, a heating power of a heating element (for heating the material used to produce the injection-molded part), a processing temperature of the raw material or raw materials used to produce the injection-molded parts to be produced by the injection molding machine, a (target) injection speed and/or injection pressure and/or injection volume of the material used to produce the injection molded parts into the respective cavities, a (target) injection work, at least one material variable characteristic of the material used to produce the injection molded parts (such as the composition of a plastic, the proportion of recycled material), a torque and/or a rotational speed of a plasticizing screw and/or a drive motor of the plasticizing screw or a characteristic value for this, a conveying behavior of the material used to produce the injection molded parts (granulate, powder, flakes, and the like) or a characteristic variable for this, such as a coefficient of friction or a bulk density, a variable characteristic of the conveying behavior of the melt produced in a plasticizing screw, such as rheological variables, e.g. the viscosity of the plastic, a variable characteristic of a (target) cooling temperature and/or cooling capacity of a tool, internal tool pressures of the melt in the cavity, temperatures of the tool surface in the cavity, a system pressure of a basic supply of a hydraulic component of the injection molding machine, an inspection parameter of an optical inspection apparatus (in particular downstream of the injection molding machine, e.g.,) for inspecting the manufactured injection-molded part (in particular for determining a variable characteristic of the quality of the injection-molded part and/or the production process), a drying variable characteristic of drying (e.g., of the material to be used for manufacturing the injection-molded part, such as plastic granulate) and/or a variable characteristic of cooling the manufactured injection-molded part, and the like, as well as combinations thereof.

The production parameters may relate to parameters of the production process of the apparatus (such as an injection molding machine) and/or a further machine (such as a peripheral device of the injection molding machine that is in communication with the machine control system (MES, abbreviation for Manufacturing Execution System)).

Preferably, the plurality of production process data sets also includes at least one and preferably several (such) production parameters.

Preferably, at least one output variable and/or at least one process flow variable is at least one and preferably several (such) production parameters.

In addition or alternatively, at least one production process variable and preferably several production process variables (of the plurality of production process variables) may be at least one and preferably a plurality of machine parameter(s) which are characteristic of at least one apparatus and/or a (used and/or to be used) component of the apparatus.

Preferably, the plurality of production process data sets also comprises at least one and preferably several (such) machine parameters.

Preferably, at least one output variable and/or at least one process variable is at least one and preferably several (such) machine parameters.

The at least one machine parameter and preferably the plurality of machine parameters can be selected from a group of machine parameters which comprise a number of cavities of the production cell currently used and/or ready for use in the manufacture of the injection molded parts, a number of cavities of the production cell that can be used at most in the manufacture of the injection molded parts, an age, the tool configuration in injection molding machines with interchangeable inserts, an age, a shot count, and/or a maintenance status of the tools and/or machines and/or machine parts used to manufacture the injection molded parts, a machine type and/or tool type of the tools and/or machines and/or machine parts used to manufacture the injection molded parts, in particular a (construction) type of a plasticizing screw, number and flow cross-section of the vent channels of a cavity of the injection molding tool, type of cooling medium for cooling the tool used in the injection molding machine (e.g., water/oil), number of plasticizations, number of core pulls and the like, as well as combinations thereof.

The selection of at least one machine parameter or the plurality of machine parameters (in particular from the above group) may depend on the application or (intended) use. The machine parameters may vary depending on which plastic molded part is being produced, for example, which injection molded part is being injection molded. Therefore, different machine parameters may be predetermined (and/or can be predetermined) for different types of plastic molded parts (such as injection molded parts) to be produced. Preferably, at least two, preferably at least three different types of plastic molded parts (such as injection molded parts) to be produced are predetermined, and at least one machine parameter, preferably a plurality of machine parameters, is assigned to each of these types.

Preferably, the plurality of production process data sets also includes at least one and preferably several (such) data records specifying an application (or use) of the preceding or past (manufactured) target plastic molded part.

Preferably, a selection of the plurality of production process data sets to be provided is carried out depending on the application of the preceding or past (manufactured) target plastic molded part specified in the respective production process data sets. Preferably, only production process data sets for providing the plurality of production process data sets are selected which have the same application (as explained above, for example, PET preforms, medical articles, beverage closures, and/or thin-walled articles) as the predetermined target plastic molded part.

In addition or alternatively, the production process data sets may comprise at least one and preferably a plurality of plastic molded part parameters (such as injection molded part parameters) which are characteristic of the respective past and/or previous (already manufactured) plastic molded part (such as injection molded part). This facilitates/accelerates the selection of the plurality of production process data sets to be provided.

In addition or alternatively, the production process data sets may (each) comprise a plurality of sensor data measured by at least one sensor device of the machine and/or the production cell and, preferably, sensor data measured by a plurality of sensor devices of the machine and/or the production cell or data derived therefrom. It is conceivable that, for example, sensor data (values) to be monitored are determined or derived from this as output variables and/or as production process variables (to be determined).

The production process variables may also be sensor data or sensor data ranges to be monitored. The (values to be monitored for) sensor data can be selected from a group of sensor data which comprise an (actual) temperature of at least one area and preferably a plurality of areas of a tool of the injection molding machine, an (actual) temperature of at least one area and preferably a plurality of areas along the plasticizing screw, an injection pressure and/or an injection speed or characteristic variables thereof, a clamping force, a clamping speed or also an acceleration when closing a tool of the injection molding machine or a characteristic variable for this, a viscosity of the material used to manufacture the injection molded parts or a characteristic variable for this, a characteristic variable for the breathing of the tool of the injection molding machine, such as the column elongation, an injection work (determined based on sensor data), an (actual) torque and/or rotational speed of a plasticizing screw and/or a drive motor of the plasticizing screw or a characteristic variable for this, a resistance during the injection process (which depends, for example, on a cross-section of the vent channels of the respective cavity of the injection molding machine), a flow and/or return temperature of a cooling medium for cooling the tool of the injection molding machine used to manufacture the injection molded parts, a flow velocity of the cooling medium, a variable characteristic of an ambient condition, such as ambient temperature, air humidity, or altitude, a variable characteristic of a property of the starting materials, such as granulate moisture or granulate temperature, a variable characteristic of a property of the finished injection molded parts (determined, for example, by an inspection and/or testing apparatus), (inspection and/or testing) variable (such as mass or physical properties), a plasticizing capacity or a variable characteristic thereof, a thermal and/or material homogenization capacity or a variable characteristic thereof, a variable characteristic of the conveying behavior of the material used to manufacture the injection molded parts in a supply area of the plasticizing screw, a compression variable characteristic of the compression behavior of the material used to manufacture the injection molded parts in the plasticizing screw, a tool cavity pressure variable characteristic of the tool cavity pressure, and the like, as well as combinations thereof.

In addition or alternatively, the production process data sets may comprise at least one and preferably a plurality of machine-internal parameters.

In addition or alternatively, the at least one (to be determined) production process variable and preferably several (to be determined) production process variables (of the plurality of production process variables) may be at least one and preferably a plurality of machine-internal parameter(s) which are characteristic of a machine-internal control and/or measurement variable.

The machine-internal parameters are, in particular, parameters which are not (usually) set and/or monitored by a user, but which are determined by the machine control system for controlling and/or regulating production.

For example, a machine-internal parameter may be an (internal) parameter of the temperature control, such as dead time and/or a slope with respect to a controller edge (temperature/time) and/or an injection pressure and/or an effective pressure during the injection process (of the material used to manufacture the injection-molded part into the cavity of the injection molding machine).

In addition or alternatively, the production process data sets may comprise at least one machine state and preferably a plurality of machine states of the apparatus.

In addition or alternatively, at least one production process variable and preferably several production process variables (of the plurality of production process variables) may be at least one machine state and preferably a plurality of machine states of the apparatus.

A machine state can be selected from a group of machine states, which include an error state, aging, a cleaning state (such as the time of the last cleaning or the like, or detected deposits in a vent duct) and/or maintenance state, a status of a heating element, a production state, a susceptibility to errors and the like, as well as combinations thereof.

In addition or alternatively, it is possible that the type and/or number and/or selection of different (e.g., those mentioned above) parameters/data of the respective production process data sets and/or production process variables and/or target plastic molded part variable(s) to be determined/determined in relation to the predetermined target plastic molded part (such as application, target plastic molded part size(s), production parameters, plastic molded part parameters (injection molded part parameters), machine parameters, sensor data, machine-internal parameters, machine status, and the like), which can be used or should be used preferably for generating a production process data set and which should therefore be collected in particular (for generating a production process data set and/or training data set), is performed automatically (e.g., by the production process determination device).

For example, a plurality of data on the above-mentioned parameters can be collected and stored (preferably together with a time stamp). The data sets can then be evaluated using pattern recognition and/or detection of deviations and/or anomalies and/or cluster analysis (e.g., using a k-means algorithm). In this way, clusters/patterns of parameters/variables can be determined in which these parameters assume values from certain value ranges and in which, for example, values of the production process variable(s) occur with increased/predetermined probabilities. In this way, overly frequent/common parameters (constellations) can be determined for a plurality of (to be determined) production process variables.

These determined production process variables or parameters can then be used or (automatically) predetermined to generate the plurality of production process data sets and/or training data sets to be provided and then to generate the training data.

Preferably, data used for this purpose to generate the production process data sets (e.g., production parameters, injection molding part parameters, machine parameters, sensor data, machine-internal parameters, machine status, . . .), are stored preferably repeatedly and particularly preferably at (in particular predeterminable) regular time intervals, on a non-volatile storage device (of the apparatus) (and retrieved from this for generating a plurality of production process data records to be provided).

Preferably, a (collection and/or determination and) storage of the data to be used for generating the production process data sets and/or for generating the plurality of production process data sets to be provided (as training data set) on the non-volatile storage device (of or of the apparatus) is triggered by a user input from an operating person (as operator). User input data characteristic of the user input (such as the type of user input) is also preferably stored (on the non-volatile storage device) and assigned to the data (collected at the same time or in the same period). A training data set (with data assigned to a common time stamp) can then be formed from this data. This offers the advantage that the production process data sets can be determined on the basis of data from an operation of the apparatus which represent a particularly fault-free and trouble-free and, for example, energy-efficient operation of the apparatus or operation that is advantageous from the operator's point of view.

It is also conceivable that data collected in a (predetermined and/or predeterminable) period before the time of user input and/or after the time of user input in relation to the parameters (which data is to be collected to generate a production process data set or training data set) and used for further data analysis and/or to generate a production process data set or training data set, so that a time sequence of the values of the corresponding parameters can be advantageously mapped.

It is preferable that the data (of the above-mentioned parameters, i.e., production parameters, injection molding part parameters, machine parameters, sensor data, machine-internal parameters, machine status) to be collected and/or used to generate the production process data records or training data records can be set and/or predetermined and/or are predetermined. This can be predetermined by a manufacturer of the apparatus, such as an injection molding machine. However, it is also conceivable that this can be predetermined and/or set by an operator (as a user).

In addition or alternatively, at least one variable is selected as the output variable, which is characteristic for a control variable for controlling and/or regulating a production process step, such as the heating process of the material to be used for manufacturing the injection molded parts by a control of at least one heating element and/or the compression process and/or conveying process of the material to be used for manufacturing the injection molded parts and/or an actuation and/or a closing process of an opening (such as the tool for manufacturing the injection molded parts), in particular via a servo and/or stepper motor, and/or the cooling process for cooling the tool to be used for manufacturing the injection molded parts, and/or a production parameter (preferably the one mentioned above).

It is also conceivable that (in addition) at least one machine state and/or a variable characteristic of a maintenance and/or fault state of the apparatus is selected as an output variable.

The apparatus or injection molding machine is preferably designed and/or set up and determined in such a way that the molding device (the tool) and the plasticization or plasticizing device and/or a component are interchangeable (and can be adapted to other designs of the target plastic molded parts to be produced) and/or different peripheral devices can be connected. A shaping device (such as a tool) and/or a peripheral device and/or a component often contains several actuators and sensors, which must be operated by the apparatus (such as an injection molding machine). The actuators can drive certain parts linearly, rotationally, or in another manner, wherein in each case we it is referred to drive axes.

Preferably, the (each) production process data set comprises characteristic variables for the (interchangeable) shaping devices (the tool) used and the plasticization or plasticizing device and/or components and/or drive type.

Preferably, a replaceable shaping device (the tool) and the plasticization or plasticizing device and/or a component of the apparatus is determined as the initial variable and/or at least one production process variable, and/or a drive type (a drive axis of a component) to be selected and/or adjusted is selected.

The present invention is further directed to a production process determination device for the at least partially automatic, preferably fully automatic, determination of at least one production process variable for the manufacture of a predetermined target plastic molded part by an apparatus, in particular an injection molding machine, for the molded production of plastic molded parts.

The apparatus comprises a plurality of production devices (preferably for performing in particular different production process steps) including a plastic supply device for supplying the plastic to be processed as raw material, a plasticizing device for plasticizing and/or homogenizing the plastic to be processed, an injection device for injecting the plasticized and/or homogenized plastic into at least one molding device, and/or the at least one molding device for molding the injected plastic into a plastic molded part.

The apparatus and/or the plurality of production devices can be adjusted according to a predetermined and/or predeterminable plurality of production process variables, which are characteristic of the production process of the plastic products to be manufactured.

According to the invention, the production process determination device is provided with a plurality of production process data sets for production processes realized for the manufacture of previous target plastic molded parts.

The production process determination device is suitable and intended to determine at least one production process variable and preferably several production process variables from the plurality of production process variables on the basis of the plurality of production process data sets and in dependence on at least one target plastic molded part variable characteristic of the predetermined target plastic molded part.

It is therefore also proposed within the scope of the production process determination device according to the invention that production processes that have already been implemented be used to determine a production process for a target plastic molded part that has not yet been manufactured.

Preferably, the production process determination device described above in connection with the method for at least partially automatic, preferably fully automatic, determination of at least one production process variable for manufacturing a predetermined target plastic molded part may have the features of the production process determination device described above individually or in combination with several features.

Preferably, the production process determination device is designed, suitable, and/or intended to carry out the above-described method for at least partially automatic, preferably fully automatic, determination of at least one production process variable for manufacturing a predetermined target plastic molded part, as well as all of the method steps already described above in connection with the method, individually or in combination with one another. Conversely, the method may be equipped with all the features described in the context of the production process determination device, either individually or in combination with each other.

The present invention is further directed to an apparatus, in particular an injection molding machine, for the molding production of plastic molded parts, wherein the apparatus comprises a plurality of production devices including a plastic supply device for supplying the plastic to be processed as raw material, a plasticizing device for plasticizing and/or homogenizing the plastic to be processed, an injection device for injecting the plasticized and/or homogenized plastic into at least one molding device, and/or the at least one molding device for molding the injected plastic into a plastic molded part, wherein the apparatus and/or the plurality of production devices can be adjusted according to a predetermined and/or predeterminable plurality of production process variables which are characteristic of the production process of the plastic products to be manufactured.

According to the invention, at least one production process variable of the predetermined and/or predeterminable plurality of production process variables is set and/or adjustable in accordance with a production process variable which is determined by a method described above (preferably according to at least one preferred embodiment) and/or is determined by a production process determination device described above.

Preferably, several and particularly preferably all production process variables are determined by a method described above (preferably according to at least one preceding preferred embodiment).

Preferably, the apparatus comprises the production process determination device according to an embodiment described above.

Preferably, the apparatus may have all the features of the apparatus described above in connection with the method for at least partially automatic, preferably fully automatic, determination of at least one production process variable for manufacturing a predetermined target plastic molded part, either individually or in combination with several features.

The present invention is further directed to the operation of an apparatus described above, wherein the operation is performed according to at least one production process variable which is determined by a method described above (preferably according to at least one preceding preferred embodiment) and/or by a production process determination device described above (preferably according to a preferred embodiment). Preferably, several and particularly preferably all production process variables are determined by a method described above (preferably according to at least one preceding preferred embodiment) and/or by a production process determination device described above.

The present invention is further directed to a computer program or computer program product comprising program means, in particular a program code, which represents or encodes at least some of and preferably all of the method steps of the method according to the invention for determining the at least one production process variable and preferably one of the described preferred embodiments, and is designed to be executed by a processor device.

The present invention is further directed to a data storage device on which at least one embodiment of the computer program according to the invention or a preferred embodiment of the computer program is stored.

The present invention has been described in relation to the manufacture of plastic molded parts. However, the present invention is also transferable to methods and apparatuses for manufacturing plastic containers (e.g., in the context of forming processes). The applicant reserves the right to also claim objects related to this.

### BRIEF DESCRIPTION OF THE DRAWINGS

Further advantages and embodiments are apparent from the accompanying drawings:

In the drawings:

FIG. 1 shows a schematic representation of an apparatus according to the invention for the molding production of plastic molded parts according to a preferred embodiment, here designed as an injection molding machine; and

FIG. 2 shows a schematic representation illustrating the method according to the invention for at least partially automatically determining at least one production process variable for manufacturing a predetermined target plastic molded part according to a preferred embodiment.

### DETAILED DESCRIPTION OF THE INVENTION

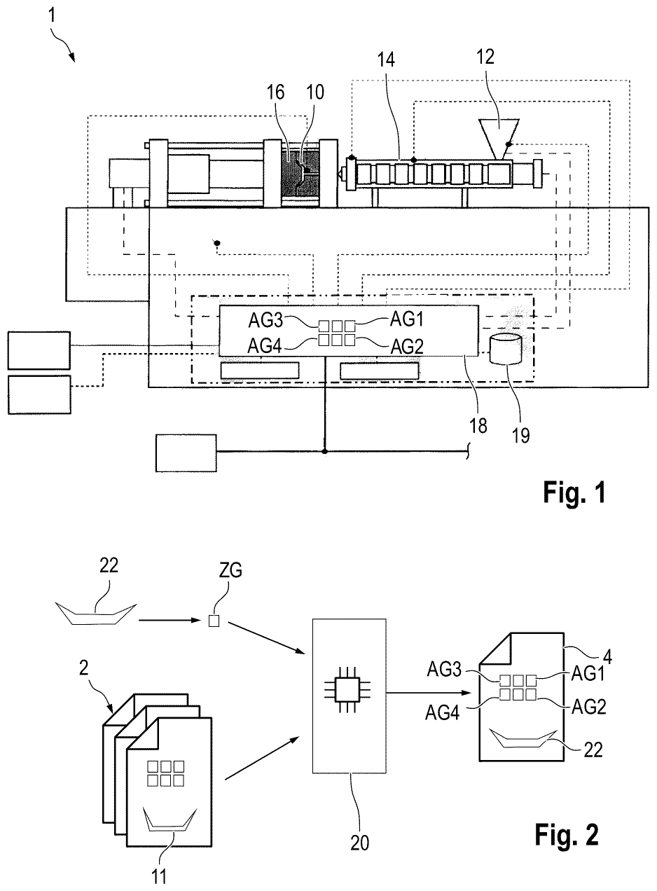

FIG. 1 shows a schematic representation of an apparatus 1 according to the invention for the molding production of plastic molded parts 10 according to a preferred embodiment, here designed as an injection molding machine.

The apparatus 1 is preferably suitable and intended for producing a plurality of (essentially) identical plastic products or plastic molded parts, in particular according to the image of a predetermined plastic molded part 10 or a model of a predetermined plastic molded part 10.

In particular, the apparatus 1 is suitable and intended for the primary molding of plastic molded parts 10 from plastic (as raw material).

The apparatus 1 has a plurality of production units 12, 14, 16 that are at least partly different from each other. Preferably, the plurality of production devices 12, 14, 16 comprises a plastic supply device 12 for supplying the plastic to be processed (as raw material), a plasticizing device 14 for plasticizing and/or homogenizing the plastic to be processed, an injection device for injecting the plasticized and/or homogenized plastic into at least one molding device 16, and the at least one molding device 16 for molding the injected plastic into a plastic molded part 10.

The apparatus 1 or the plurality of production devices 12, 14, 16 can be adjusted according to a predeterminable plurality of production process variables AG1, AG2, AG3, AG4, . . . which are characteristic of the production process of the plastic products 10 to be manufactured.

FIG. 2 shows a schematic representation illustrating the method according to the invention in accordance with a preferred embodiment for at least partially automatic determination of at least one production process variable for manufacturing a predetermined target plastic molded part 22.

The manufacture of the predetermined target plastic molded part 22 is to be carried out by an apparatus 1 for the molded manufacture of plastic molded parts, in particular an injection molding machine, as described and shown in FIG. 1, for example. The apparatus 1 is preferably suitable and intended for producing a plurality of (essentially) identical plastic products or plastic molded parts, in particular according to the image of a predetermined plastic molded part 10 or a model of a predetermined plastic molded part 10.

Reference numeral 18 denotes a control device of the apparatus 1 (as a machine control), which is suitable and intended for controlling the (fully) automatic manufacturing process of the plurality of plastic molded parts. Preferably, the control device 18 is suitable and intended for controlling the plurality of production devices 12, 14, 16.

A plurality of production process variables AG1, AG2, AG3, AG4 may be predetermined, and the control of the manufacturing steps or the production process or the control of the apparatus 1 and/or the plurality of production devices 12, 14, 16 is carried out depending on the plurality of production process variables AG1, AG2, AG3, AG4.

The apparatus 1 may have a storage device 19 on which, for example, the plurality of production process variables AG1, AG2, AG3, AG4 can be stored.

FIG. 2 illustrates that a plurality of production process data sets 2 are provided for determining at least one production process variable and, preferably, for determining the plurality of production process variables AG1, AG2, AG3, AG4.

The plurality of production process data sets 2 refers to production processes that have been realized/already carried out for the manufacture of previous target plastic molded parts 11.

In particular, production processes 2 that have already been realized are initially specified.

Based on the plurality of production process data sets 2 and depending on at least one target plastic molded part variable ZG characteristic of the predetermined target plastic molded part 22, at least one production process variable AG1 and preferably several (particularly preferably all) production process variables of the plurality of production process variables AG1, AG2, AG3, AG4 is determined by a production process determination device 20, in particular a processor-based device.

It is preferably proposed that a production process is automatically created (by the production process determination device 20, in particular a processor-based device) by a trained neural network, preferably by a written or verbal input of the requirements for the production process.

The network was preferably initially trained with production processes 2 that had already been implemented. The created or determined (production) process 4 preferably contains all necessary components, commands, auxiliary controls, and their parameterization.

The created draft can then preferably be expanded and refined through chat interaction (generative AI).

Preferably, the system is also able to provide assistance and suggest optimizations.

The applicant reserves the right to claim all features disclosed in the application documents as essential to the invention, provided that they are new, either individually or in combination, compared to the prior art. It should also be noted that the individual figures also describe features that may be advantageous in themselves. The skilled person will immediately recognize that a particular feature described in a figure may be advantageous even without adopting other features from that figure. Furthermore, the skilled person will recognize that advantages may also result from a combination of several features shown in individual or different figures.

### LIST OF REFERENCE SIGNS

1 apparatus
2 plurality of production process data sets
4 determined production process
10 plastic molded part that can be manufactured by apparatus 1
11 previous target plastic molded part
12 plastic supply device
14 plasticizing device
16 molding device
18 control device
19 storage device
20 production process determination device
22 target plastic molded part
AG1, AG2, AG3, AG4 production process variables
ZG target plastic molded part variable characteristic of the production process of the plastic products to be manufactured.

1. A method for the at least partially automatic, preferably fully automatic, determination of at least one production process variable for the manufacture of a predetermined target plastic molded part by an apparatus, in particular an injection molding machine, for the molding production of plastic molded parts, wherein the apparatus comprises a plurality of production devices comprising a plastic supply device for supplying the plastic to be processed as raw material, a plasticizing device for plasticizing and/or homogenizing the plastic to be processed, an injection device for injecting the plasticized and/or homogenized plastic into at least one shaping device and/or the at least one shaping device for shaping the injected plastic into a plastic molded part, wherein the apparatus and/or the plurality of production devices can be adjusted according to a predetermined and/or predeterminable plurality of production process variables which are characteristic of the production process of the plastic products to be manufactured, wherein
a plurality of production process data sets are provided for production processes realized for the manufacture of previous target plastic molded parts, and that, on the basis of the plurality of production process data sets and depending on at least one target plastic molded part variable characteristic of the predetermined target plastic molded part, at least one production process variable and preferably several production process variables of the plurality of production process variables is or are determined.

2. The method according to claim 1,
the target plastic molded part is a plastic molded part selected from a group comprising medical technology products and/or products for the pharmaceutical sector and/or from the healthcare sector and/or the medical sector, in particular syringes and/or pipette tips and/or pipettes, closures, in particular for (beverage) containers, caps, containers, in particular Petri dishes and/or containers for analysis liquids and/or (beverage) cups, and/or packaging, in particular thin-walled packaging, and/or in-mold labeling products and the like, as well as combinations thereof.

3. The method according to claim 1, wherein
the provided plurality of production process data sets relates to the manufacture of previous target plastic molded parts which originate from the same product category as the predetermined target plastic molded part.

4. The method according to claim 1, wherein
the provided and/or to be provided plurality of production process data sets is/are selected and/or provided depending on at least one target plastic molded part variable, which is selected from a group comprising a cross-sectional shape, cross-sectional areas, dimensions, weight, geometric sizes, material, intended use, reusability, a shape, volume, wall thickness, outer and/or inner surface size, and the like, as well as combinations thereof.

5. The method according to claim 1, wherein
the at least one production process variable and, preferably, the plurality of production process variables are determined by a machine learning production process model comprising a set of parameters which are set to values learned as a result of a training process in which the plurality of production process data sets relating to production processes that have already been used for previously and/or past manufactured target plastic molded parts.

6. The method according to claim 1,
wherein the at least one target plastic molded part variable serves as at least one input variable of the production process model, in particular the (fully) trained production process model, wherein 3D data of the tool and/or of the predetermined target plastic part to be manufactured is preferably used as the target plastic molded part variable, and
the machine learning production process model maps the at least one input variable to the at least one production process variable to be used for manufacturing the predetermined target plastic molded part or a variable characteristic thereof and/or outputs as output variable(s) the at least one production process variable to be used for manufacturing the predetermined target plastic molded part or a variable characteristic thereof.

7. The method according to claim 1, wherein
the training process is supervised learning.

8. The method according to claim 1, wherein
the at least one production process variable, and preferably the plurality of production process variables, is selected from a group of production process variables comprising variables that are characteristic of at least one component of the apparatus, commands, control devices, and/or parameters of the apparatus and the like, as well as combinations thereof.

9. The method according to claim 1, wherein
the determined plurality of production process variables is characteristic of the entire production process.

10. The method according to claim 1, wherein
the at least one determined production process variable or the determined plurality of production process variables can be changed by operator input.

11. The method according to claim 1, wherein
the at least one determined production process variable or the determined plurality of production process variables can be changed and/or expanded and/or refined by a chat interaction with an operator, preferably by voice input and/or text input by the operator.

12. The method according to claim 1, wherein
at least one production process variable to be optimized by an operator is determined for output to the operator.

13. The method according to claim 1, wherein
the at least one production process variable to be optimized by the operator is output to the operator together with at least one limit value, by which the operator is given an optimization range for the production process variable to be optimized.

14. The method according to claim 1, wherein
the determined plurality of production process variables can be used to determine and/or is/will be determined by the apparatus to establish a sequence of production steps to be performed.

15. The method according to claim 1, wherein
test functions are predetermined and/or can be predetermined, by which the feasibility of a production sequence specified and/or to be specified on the basis of the determined plurality of production sequence variables can be automatically checked and/or is checked.

16. A production process determination device for at least partially automatic, preferably fully automatic, determination of at least one production process variable for manufacturing a predetermined target plastic molded part using an apparatus, in particular an injection molding machine, for the molding production of plastic molded parts, wherein the apparatus comprises a plurality of production devices comprising a plastic supply device for supplying the plastic to be processed as raw material, a plasticizing device for plasticizing and/or homogenizing the plastic to be processed, an injection device for injecting the plasticized and/or homogenized plastic into at least one molding device, and/or the at least one molding device for molding the injected plastic into a plastic molded part, wherein the apparatus and/or the plurality of production devices can be adjusted according to a predetermined and/or predeterminable plurality of production process variables which are characteristic of the production process of the plastic products to be manufactured, wherein
the production process determination device is provided with a plurality of production process data sets relating to production processes realized for the manufacture of previous target plastic molded parts, and that the production process determination device is configured for determining at least one production process variable and preferably several production process variables from the plurality of production process variables on the basis of the plurality of production process data sets and in dependence on at least one target plastic molded part variable characteristic of the predetermined target plastic molded part.

17. An apparatus, in particular an injection molding machine, for the molded production of plastic molded parts, wherein the apparatus comprises a plurality of production devices comprising a plastic supply device for supplying the plastic to be processed as raw material, a plasticizing device for plasticizing and/or homogenizing the plastic to be processed, an injection device for injecting the plasticized and/or homogenized plastic into at least one molding device, and/or the at least one molding device for molding the injected plastic into a plastic molded part, wherein the apparatus and/or the plurality of production devices can be adjusted according to a predetermined and/or predeterminable plurality of production process variables which are characteristic of the production process of the plastic products to be manufactured, wherein
at least one production process variable of the predetermined and/or predeterminable plurality of production process variables be and/or is set in accordance with a production process variable which is determined by a method according to at least one preceding claim and/or is determined by a production process variable determination device according to the preceding claim.

18. The operation of an apparatus according to claim 17, wherein the operation is carried out according to at least one production process variable which is determined by a method according to at least one preceding claim and/or is determined by a production process determination device according to the preceding claim.
